(19) United States
(12) Patent Application Publication
(10) Pub. No.: US 2014/0217117 A1
(43) Pub. Date: Aug. 7, 2014

(54) Base Grooved Collapsible Bottle

(71) Applicant: OP-HYGIENE IP GmbH, Niederbipp (CH)

(72) Inventor: Ali Mirbach, Issum (DE)

(73) Assignee: OP-HYGIENE IP GmbH, Niederbipp (CH)

(21) Appl. No.: 14/174,407

(22) Filed: Feb. 6, 2014

(30) Foreign Application Priority Data
Feb. 6, 2013 (CA) 2805152

(51) Int. Cl. B65D 35/00

(52) U.S. Cl. CPC B05B 11/048
USPC 222/95; 220/4.01; 222/107; 222/181.3

(57) ABSTRACT

A thin walled collapsible container having an outlet end and a closed base end intermediate which there are provided walls extending longitudinally of the container from the outlet end to the base end, the walls including at least a front wall and an opposite wall opposite the front wall and walls joining the front wall with the opposite wall, and in which an inwardly extending medial groove is provided between the front wall and the opposite wall, the groove extending downwardly within a bottom wall forming the base end inwardly towards the outlet end. Visible indicia such as a printed label may be provided on the front wall which label, in an uncollapsed container held by its outlet end, is disposed to be directed in a particular direction for viewing by a user and in which during collapse of the collapsible container by withdrawing fluid therefrom, the container collapses with, to a large extent, the front wall carrying the labelling to continue to be directed roughly in the same direction.

### SCOPE OF THE INVENTION

This invention relates to collapsible containers for fluids from which fluid may be dispensed and, more particularly, to a collapsible bottle with a structure which on collapsing resists twisting of portions of the bottle.

### BACKGROUND OF THE INVENTION

Collapsible dispensers for soap and other fluids are known as for use, for example, in fluid dispensers such as that taught by the applicant's U.S. Pat. No. 5,836,482 entitled Automatic Fluid Dispenser, issued Nov. 17, 1998, the disclosure of which is incorporated herein. The collapsible container may comprise a container such as those which are self-supporting when filled with material yet collapse upon themselves such as, for example, disclosed in the above-noted U.S. Pat. No. 5,836,482 and, as well, in U.S. Pat. No. 7,530,475 to Ophardt, issued May 12, 2009 and disclosed in U.S. Patent Publication US 2009/0114679, published May 7, 2009 also to Ophardt et al, the disclosures of which are also incorporated herein by reference.

The inventor of the present application has appreciated a disadvantage of many previously known such collapsible containers that during collapsing, the bottles may have a tendency to twist about a longitudinal axis. The inventor of this application has also appreciated the disadvantage that back, side or front surfaces of the bottle do not adopt consistent configurations when the bottle is collapsed and thus suffer the disadvantages as not providing surfaces upon which labels and the like may be provided and be appropriately directed as, for example, forwardly for viewing by a user while the container is collapsed.

### SUMMARY OF THE INVENTION

To at least partially overcome these disadvantages of previously known devices, the present invention provides a collapsible container having an outlet end and a closed base end opposite the outlet end and in which an inwardly extending medial groove is provided extending inwardly within the base end.

An object of the present invention is to provide a configuration for a collapsible bottle which provides for advantageous collapsing of the bottle as fluid is withdrawn therefrom.

Another object is to provide a collapsible bottle with a wall carrying labelling indicia in which during collapsing of the bottle by withdrawal of fluid therefrom, the wall is maintained directed in a similar orientation to facilitate continued viewing of the indicia.

In accordance with one aspect of the present invention, there is provided a thin walled collapsible container having an outlet end and a closed base end intermediate which there are provided walls extending longitudinally of the container from the outlet end to the base end, the walls including at least a front wall and an opposite wall opposite the front wall and walls joining the front wall with the opposite wall, and in which an inwardly extending medial groove is provided between the front wall and the opposite wall, the groove extending downwardly within a bottom wall forming the base end inwardly towards the outlet end. Preferably, the groove is a continuous groove which not only extends across the bottom wall but also extends between the front wall and the opposite wall into side walls intermediate the front wall and the opposite wall. More preferably, the container includes at least the front wall, a rear wall opposite the front wall and two side walls with the groove comprising an inwardly extending medial groove between the front wall and the rear wall within each of the first side wall, the bottom side wall and the second side wall extending continuously from within the first side wall to the bottom wall across the bottom wall within the bottom wall to the second side wall and within the second side wall.

Preferably, visible indicia such as a printed label may be provided on the front wall which label, in an uncollapsed container held by its outlet end, is disposed to be directed in a particular direction fir viewing by a user and in which during collapse of the collapsible container by withdrawing fluid therefrom, the container collapses with, to a large extent, the front wall carrying the labelling to continue to be directed roughly in the same direction. Preferably, the groove provides for collapsing of the bottle with the front wall and rear wall to be drawn together with the depth of the groove as measured in a direction between the front wall reducing as the container is collapsed.

In accordance with the present invention, the collapsible bottle is preferably provided in conjunction with the dispenser for dispensing fluid therefrom and in which the front wall is directed forwardly of the dispenser. The dispenser preferably has a cover for enclosing the bottle and a mechanism for dispensing fluid from the bottle, preferably with the cover having a forwardly directed window therethrough via which the front wall of the container may be viewed.

In one aspect, the present invention provides a thin walled collapsible container,

the container comprising an outlet end, a closed base end, a front wall, a rear wall and two side walls, namely a first side wall and second side wall,

the container closed but for an opening from the outlet end,

the outlet end having a top wall, the top wall including a central portion about a neck open to the opening, the top wall merging with the front, rear and two side walls,

the front, rear and two side walls extending longitudinally of the container from the outlet end to the base end,

the base end having a bottom wall merging into the front, rear and two side walls,

an inwardly extending medial groove between the front wall and the rear wall within each of the first side wall, the bottom wall and the second side wall extending continuously from within the first side wall, downwardly within the first side wall across the bottom wall within the bottom wall and upwardly within the second side wall within the second end wall.

### BRIEF DESCRIPTION OF THE DRAWINGS

Further aspects and advantages of the present invention will become apparent from the following description taken together with the accompanying drawings in which:

FIG. 1 is an exploded perspective view of a dispenser with a collapsible bottle in accordance with the first embodiment of the present invention;

FIG. 2 is a perspective view of the bottle shown in FIG. 1;

FIG. 3 is a front view of the bottle shown in FIG. 2;

FIG. 4 is a side view of the bottle shown in FIG. 2;

FIG. 5 is a top view of the bottle shown in FIG. 2;

FIG. 6 is a bottom view of the bottle shown in FIG. 2;

FIG. 7 is a cross-sectional view along section line A-A′ in FIG. 3;

FIG. 8 is a cross-sectional view similar to FIG. 7 but with the bottle partially collapsed;

FIG. 9 is a cross-sectional view similar to FIG. 7 but with the bottle fully collapsed;

FIG. 10 is a cross-sectional view along section line B-B′ in FIG. 3;

FIG. 11 is a cross-sectional view similar to FIG. 10 but with the bottle partially collapsed;

FIG. 12 is a cross-sectional view similar to FIG. 10 but with the bottle fully collapsed;

FIG. 13 is a first perspective view of a bottle in accordance with a second embodiment of the invention;

FIG. 14 is a second perspective view of the bottle of FIG. 13;

FIG. 15 is a side view of the bottle of FIG. 14;

FIG. 16 is a bottom view of the bottle of FIG. 15;

FIG. 17 is a perspective view of a bottle in accordance with a third embodiment of the invention; and

FIG. 18 is a perspective view of a bottle in accordance with a fourth embodiment of the invention.

### DETAILED DESCRIPTION OF THE DRAWINGS

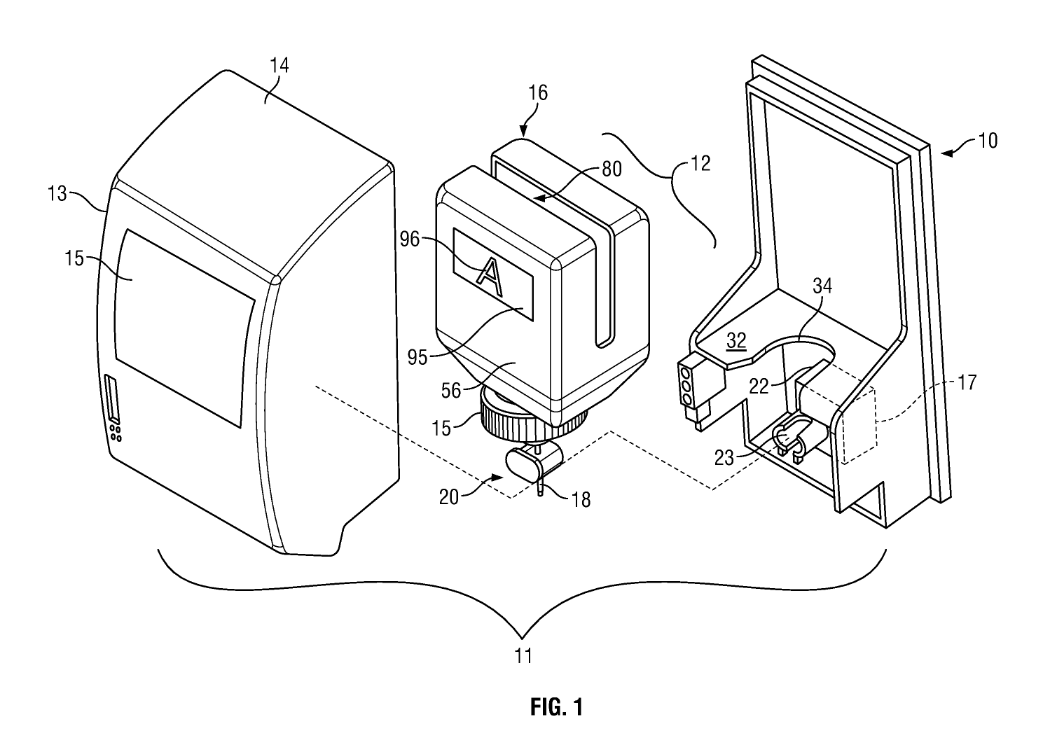

Reference is made to FIG. 1 which illustrates a soap dispenser 11 similar to that taught by the above-mentioned U.S. Pat. No. 5,836,482, however, in which a container bottle 16 is shown as including a medial groove 80 in accordance with the present invention.

The dispenser 11 comprises a housing 10, a replaceable bottle and pump unit 12 and a cover 14. The housing 10 is adapted to be mounted vertically as to a wall. The cover 14 is adapted to be removably coupled to the housing 10 to permit insertion and removal of the unit 12. The replaceable bottle and pump unit 12 comprises a collapsible bottle 16 and a pump 20. In a known manner, the replaceable unit 12 can be coupled to the housing 10 and covered by the cover 14 and fluid then dispensed by the pump 20 out a discharge outlet 18 and onto the hand of a user disposed below the outlet 18. With operation of the pump 20, fluid is drawn from the bottle 16. As the bottle 16 is closed but for an opening at its outlet end, with dispensing of fluid by the pump 20, vacuum is created within the bottle 16 which collapses the bottle as fluid is dispensed.

The pump 20 shown schematically illustrates an automatic pump powered by an electric motor and which senses the presence of a user's hand below the outlet 18 in a known manner. Various other pumps, however, are adapted for use with the container 16 in accordance with the present invention including manually operated pumps.

As shown in FIG. 1, as is preferred, the bottle is disposed with its outlet end directed downwardly, however, this is not necessary and the bottle may be disposed with its outlet end directed upwardly. The dispenser 11 may preferably include a cover 14 although this is not necessary. Where a cover 14 is provided, it may preferably be provided with a window opening 13 therethrough, which may be enclosed by a transparent plastic window pane 15, however, providing such a pane is not necessary. The window opening 13 is preferably provided such that a user may through the window view labelling indicia 96 such as a stylized A shown in FIG. 1 carried on a front wall 56 of the bottle 16.

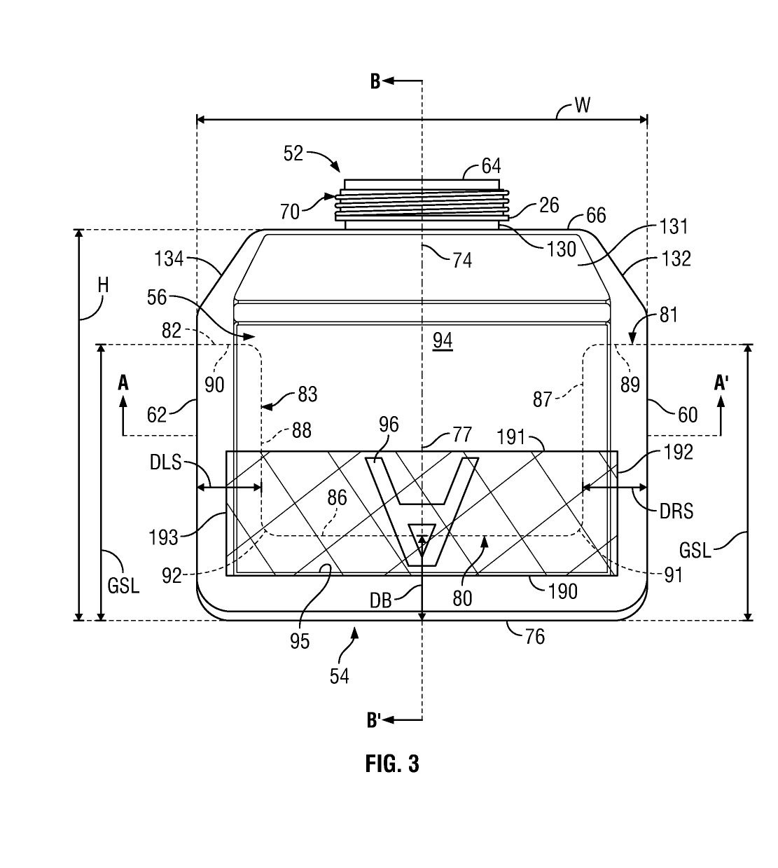

The bottle or container as seen in FIG. 3 has a cylindrical outlet neck 70 which is externally threaded at its end to threadably receive a cap 15 as shown in FIG. 1, The neck 70 has a radially outwardly extending flange 26 disposed closely under a top wall 66 of the bottle 16 so as to present a radially extending support slot 130 therebetween. The housing 10 has a horizontally extending support plate 32 with a forwardly open U-shaped slot 34 therein sized to be complementary to the support slot 130 such that the support plate 32 can be received in the support slot 130 and thus the housing 10 may rigidly secure and support the container 16 locating the container 16 and particularly the relatively rigid outlet neck 70 at fixed location relative to the housing 10. As seen in FIG. 1, the cap 15 supports and carries the pump 20. Fluid is conducted via the cap 15 to the pump 20 and then from the pump 20 out a dispensing outlet 18. A motor, not shown, is mounted in a motor casing 22 on the housing 10 carrying a forwardly opening socket 23 which is sized for removable coupling with the pump 20 therein for operative coupling of the motor to drive the pump 20 when the replaceable unit 12 comprising the bottle 16 and the pump 20 is coupled to housing 10.

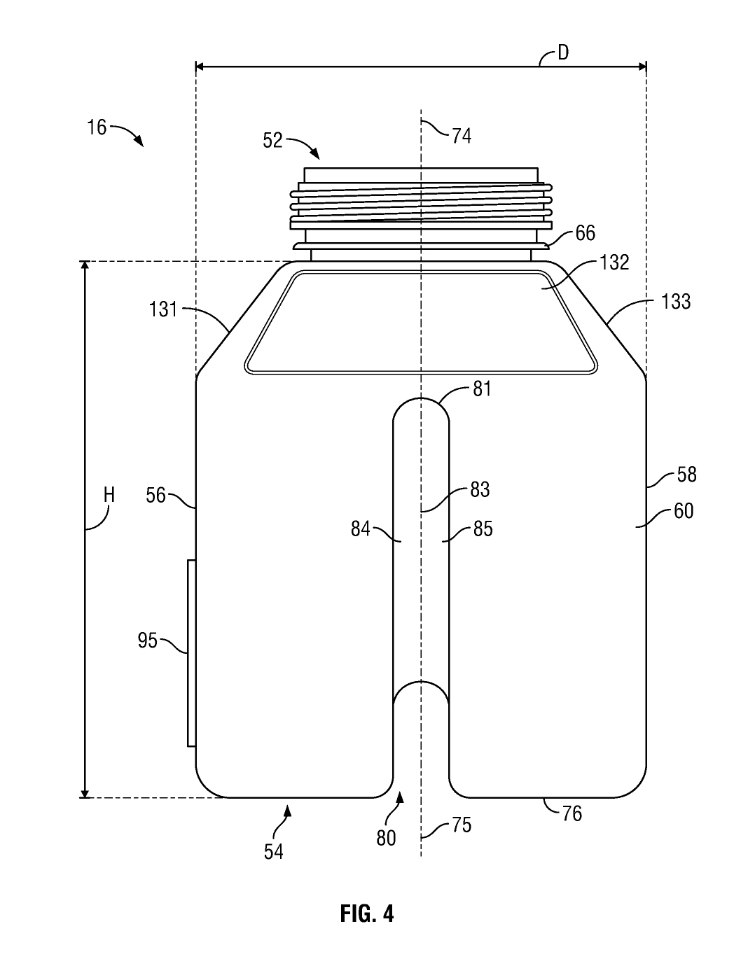

The bottle 16 has an outlet end 52 and abuse end 54. in a preferred manner of use of the bottle 16 as illustrated in FIG. 1, the outlet end 52 is directed downwardly, however, notwithstanding this, in FIGS. 3 and 4, the outlet end 52 is shown to be an upper end of the bottle 16 and the base end 54 as a lower end of the bottle. This is not necessary and the bottle 16 can be used in a position such as inverted or on its side or the like since dispensing by use of the pump 20 draws fluid out of the bottle with collapse of the bottle. Preferably, with the bottle 16 entirely filled with fluid to be dispensed and containing no gas, pumping the liquid from the bottle will occur irrespective of the up or down orientation of the bottle. Nevertheless, in the disclosure, when referred. to as up or down, this is intended to refer to a configuration as seen in FIGS. 3 and 4 with the outlet end 52 being an upper end and the base end 54 a lower end.

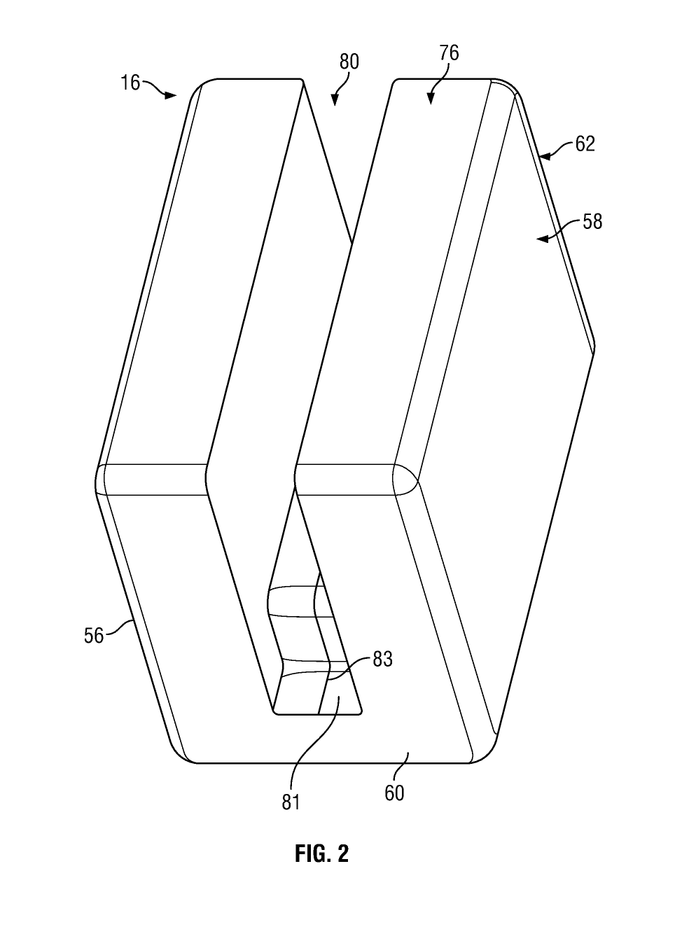

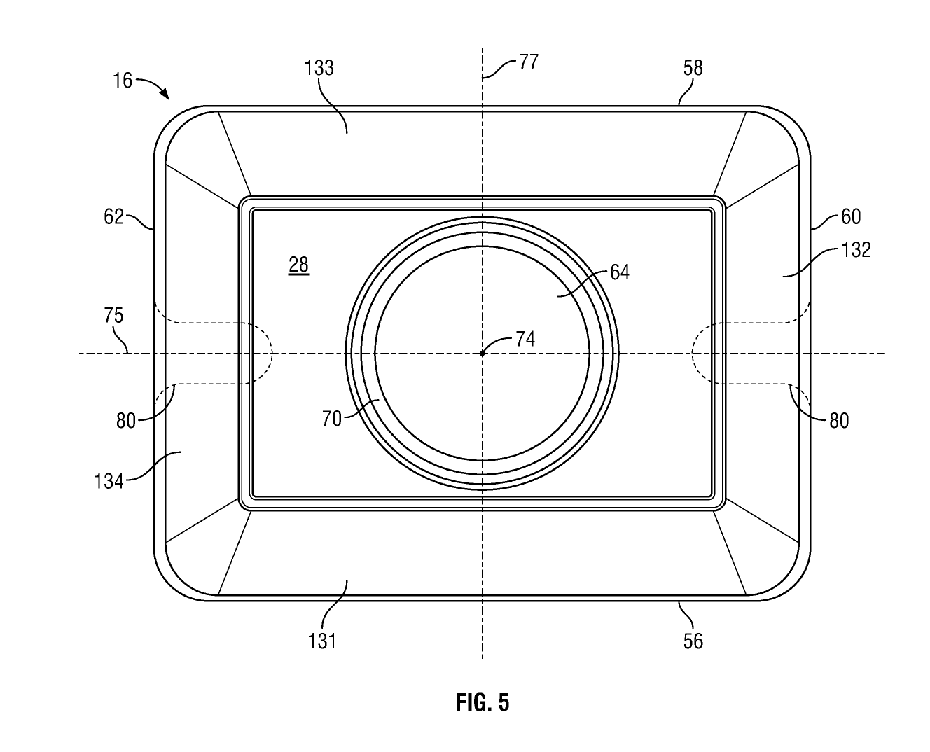

The bottle 16 has a generally rectangular cross-section and, as best seen in FIGS. 2 to 6, includes a front wall 56, a rear wall 58 and two side walls, namely, a right side wall 60 and a left side wall 62. The bottle 16 is closed but for an opening 64 from the outlet end 52. The outlet end 52 has the top wall 66 with a generally rectangular perimeter as seen in end view in FIG. 5. The top wall 66 includes a rectangular central portion 28 about the axially extending neck 70. The neck 70 is open to the opening 64. The top wall 66 merges with the front wall 56, rear wall 58, right side wall 60 and left side wall 62. In this regard, the top wall includes outwardly of the central portion trapezoidal shoulder portions namely, front trapezoidal shoulder portion 131, right side trapezoidal shoulder portion 132, rear trapezoidal shoulder portion 133 and left, side trapezoidal shoulder portion 134, each of which bridges between the central portion 28 and a respective of the front wall 56, the right side wall 60, the rear wall 38 and the left side wall 62, In the preferred embodiment, the neck 70 has an axis extending coaxially therethrough which axis is coincident with a longitudinal 74 through the bottle 16. The bottle 16 is symmetrical about a flat central plane 75 intermediate the front wall 56 and the rear wall 58 and which flat central plane 75 includes the longitudinal 74. A flat transverse plane 77 is defined intermediate the side walls 60 and 62 which flat transverse plane 77 also includes the longitudinal 74. The bottle 16 of FIG. 2 is also symmetrical about the flat transverse plane 77.

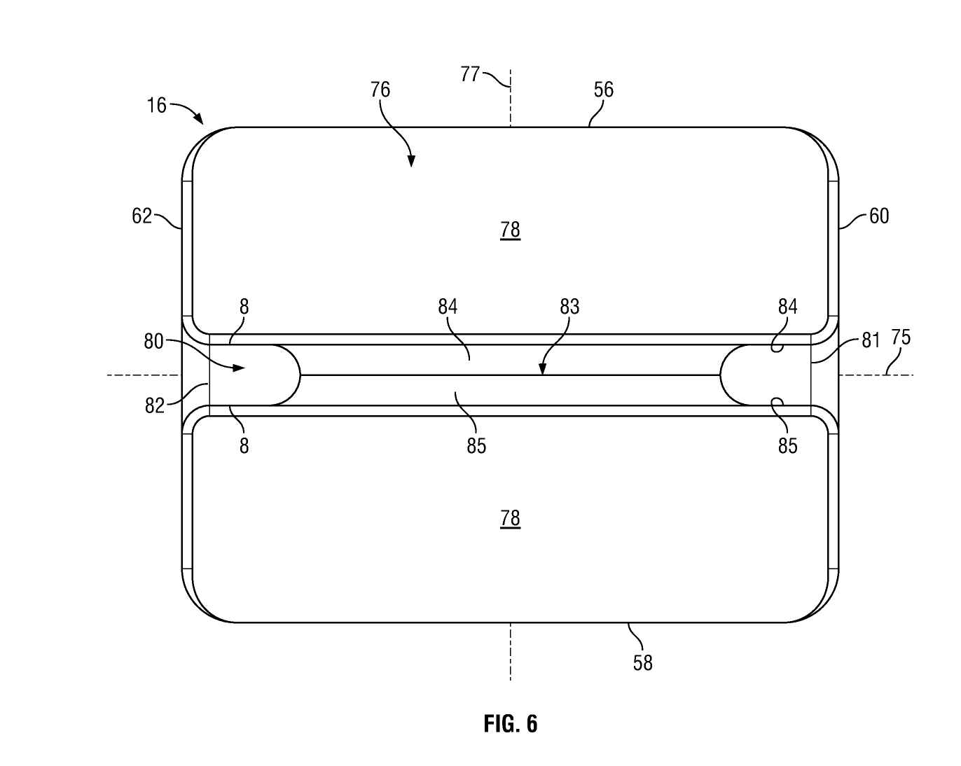

The base end 54 has a bottom wall 76 with a generally rectangular perimeter as seen in end view in FIG. 6. The bottom wall 76 includes a central portion 78 which merges into the front wall 56, rear wall 58 and the two side walls 60 and 62. The base end 54 preferably has the central portion 78 provide support portions disposed in a flat plane normal to the longitudinal 74 of the bottle 16 and which may serve to support the bottle 16 when fined with fluid on a horizontal support suffice, not shown, with the longitudinal 74 of the bottle 16 to extend vertically upwardly normal to the horizontal support surface.

The groove 80 is an inwardly extending medial groove provided between the front wall 56 and the rear wall 58 within each of the first side wall 60, the bottom wall 76 and the second sidewall 62. Referring to FIGS. 2 and 3, the medial groove 80 extends continuously from within the first side wall 60 downwardly within the first side wall to the bottom wall 76, across the bottom wall 76 within the bottom wall 76 and then upwardly within the second side wall 62. The groove 80 has a first groove end 81 within the first side wall 60 and a second groove end 82 within the second side wall 62. The groove 80 extends continuously from the first groove end 81 to the second groove end 82 successively within the first side wall 60, the bottom wall 76 and second side wall 62. The first groove end 81 is spaced downwardly from the top wall 66 toward the bottom wall 76 and, similarly, the second groove end 82 is spaced downwardly from the top wall 66 toward the bottom wall 76.

In the preferred embodiment, the groove 80 is symmetrical about the flat central plane 75 and, as well, is symmetrical about the flat transverse plane 77. The groove 80 has a valley apex 83 which extends in the center of the groove 80 from the first groove end 81 to the second groove end 82. The groove 80 is formed by a front valley wall 84 and a rear valley wall 85, each of which extends inwardly to the valley apex 83. The front valley wall 84 merges forwardly into the bottom wall 76 where the groove 80 is within the bottom wall 76 and, similarly, the front valley wall 84 merges forwardly into the right side wall 60 where the groove 80 is within the right side wall 60 and the front valley wall 84 merges forwardly with the left side wall 62 where the groove 80 is within the left side wall 62. Similarly, the rear valley wall 85 merges rearwardly into the bottom wall 76 where the groove 80 is within the bottom wall 76. The rear valley wall 85 merges rearwardly into the right side wall 60 where the groove 80 is in the right side wall 60 and the rear valley wall 85 merges rearwardly into the left side wall 62 where the groove 80 is within the left side wall 62. In the preferred embodiment, in cross-sections normal to the valley apex 83, the groove 80 is generally symmetrical about the transverse plane 75 and has, as shown in the preferred embodiment, a cross-sectional profile which is substantially constant.

Referring to FIG. 3, the valley apex 83 in the preferred embodiment includes a bottom segment 86 which extends parallel to the bottom wall 76, a right side segment 87 which extends parallel to the right side wall 60 and a left side segment 88 which extends parallel to the left side wall 62. in the preferred embodiment, an extent to which the valley apex 83 is located inwardly from the bottom wall 76 is indicated as being a constant distance and the bottom segment 86 is shown as being disposed inwardly a depth DB in FIG. 3 from the bottom wall 76. The right side segment 87 is shown being a constant distance inwardly from the right side wall 60 indicated as depth DRS in FIG. 3 from the right side wall 60 and the left side segment 88 is shown as being a constant distance inwardly from the left side wall 62 indicated as depth DLS from the left side wall 62. The distances DRS and DLS are equal.

The valley apex 83 is shown to include at the first groove end 81 a right side end segment 89 which extends as a straight line outwardly towards the right side wall 60 and upwardly towards the top wall 66. Similarly, the valley apex 83 includes at the second groove end 82 a left side end segment 90 which extends as a straight line outwardly towards the left side wall 62 and upwardly towards the top wall 66. The valley apex's right side end segment 89 and left side end segment 90 may extend normal to the respective side wall or be disposed at some angle thereto but need not be linear and may, for example, be curved.

Between the bottom segment 86 and the right side segment 87, the valley apex 83 is provided as a curved corner segment 91 and similarly between the bottom segment 86 and the left valley segment 88, the valley apex 83 is provided as a curved corner segment 92. These two curved corner segments 91 and 92 are shown to mirror the curvatures of the junction of the bottom wall and the respective side wall, however, this is not necessary.

The front wall 56 is shown to provide a central portion 94 disposed substantially in a flat plane parallel to the central plane 75 and directed forwardly in a direction normal to the central plane 75. A thin planar label 95 is shown as cross-hatched and secured to the front wall 56 and displaying thereon a visual indicia 96 in the form of the letter A, by example. The label 95 advantageously provides information about the bottle 16 or its contents or the dispenser or otherwise and is disposed such that the visual indicia 96 is visually apparent on viewing the bottle 16 from a direction forwardly of the front wall 56 of the bottle, and in the case where the bottle is disposed on a housing 10 with the cover 14 in place, the visual indicia 96 of the label 95 is visually apparent in the forward direction through the window opening 13.

In use of the bottle 16, with the bottle 16 mounted in the dispenser 11 and the bottle filled with a fluid, with operation of the pump 20, fluid is dispensed from the bottle 16 creating a vacuum within the bottle which collapses the bottle 16. The bottle 16 is preferably blow molded from plastic material with each of its wafts being formed of a relatively thin flexible sheet of plastic material.

The medial groove 80 assists in controlling the collapse of the bottle 16 in a relatively controlled manner which assists in preventing, during collapse of the bottle 16, the twisting of the bottle 16 about its longitudinal 74 which twisting might tend to skew the front waft 56 to be directed in a direction significantly other than forwardly towards the window opening 13 as, for example, towards one side.

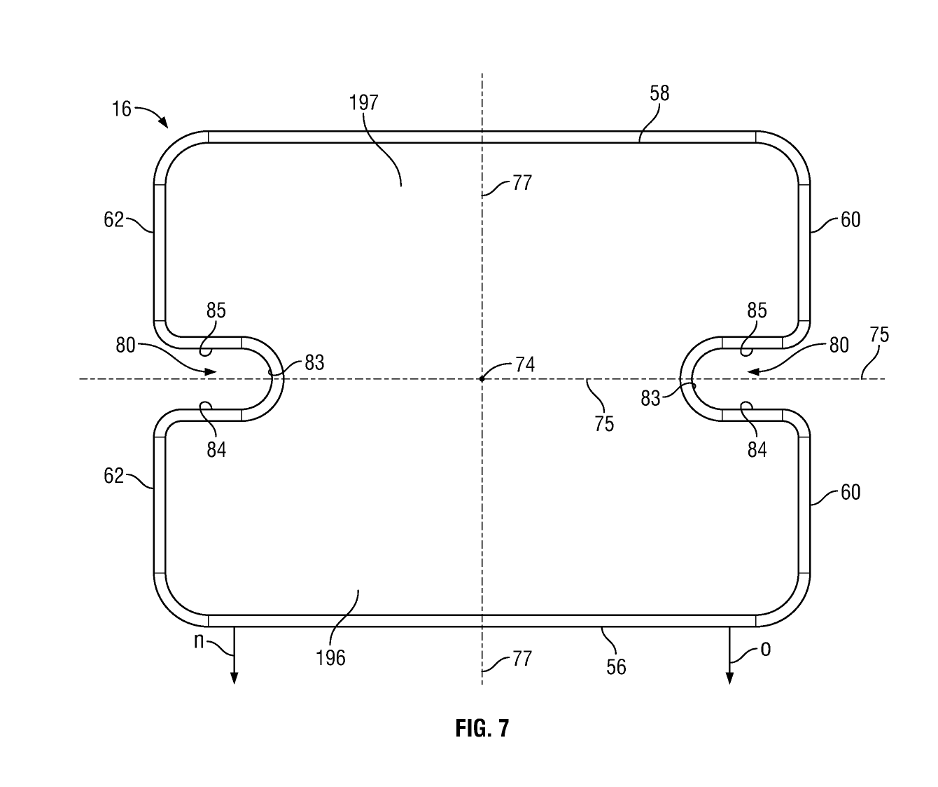

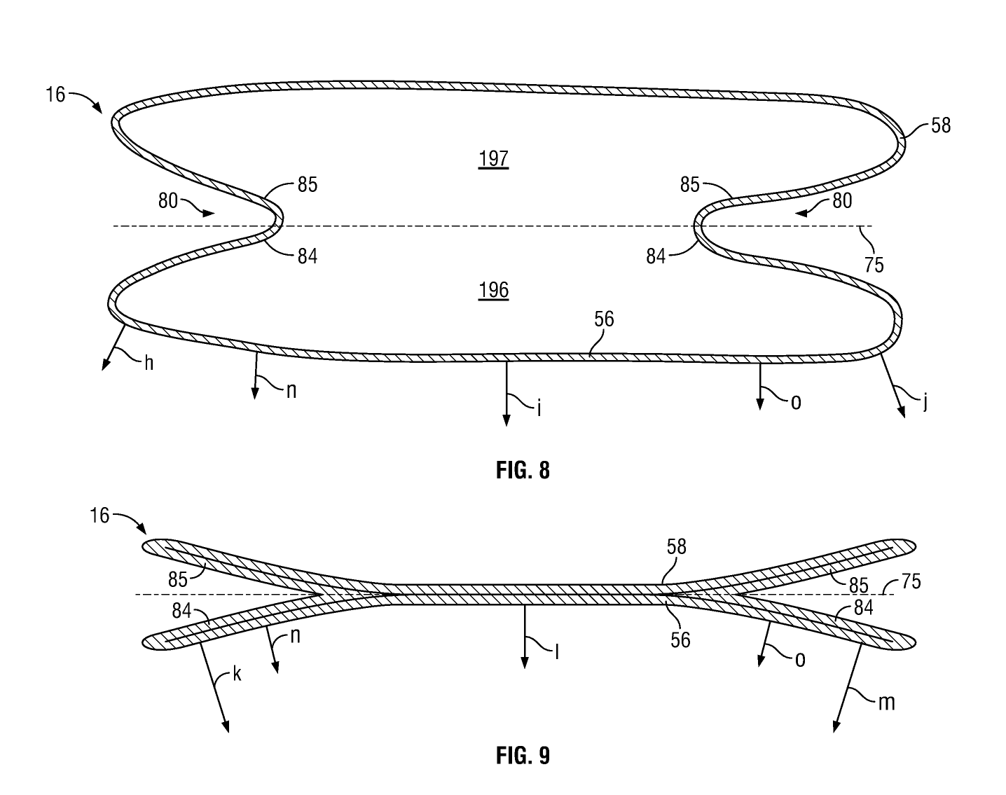

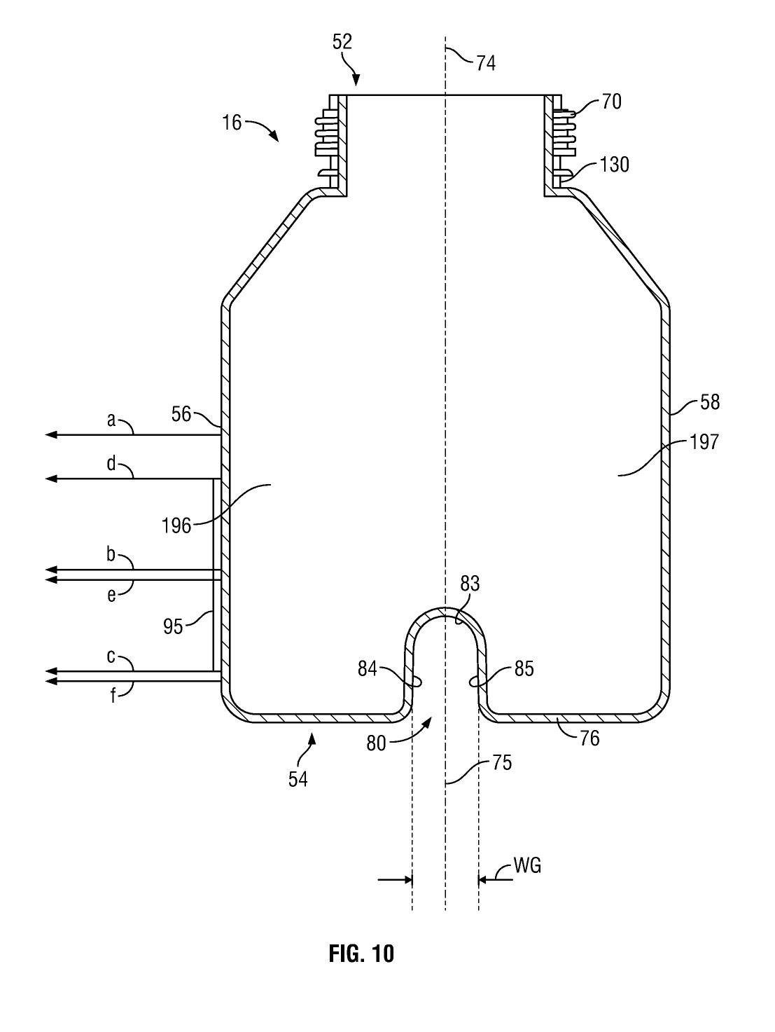

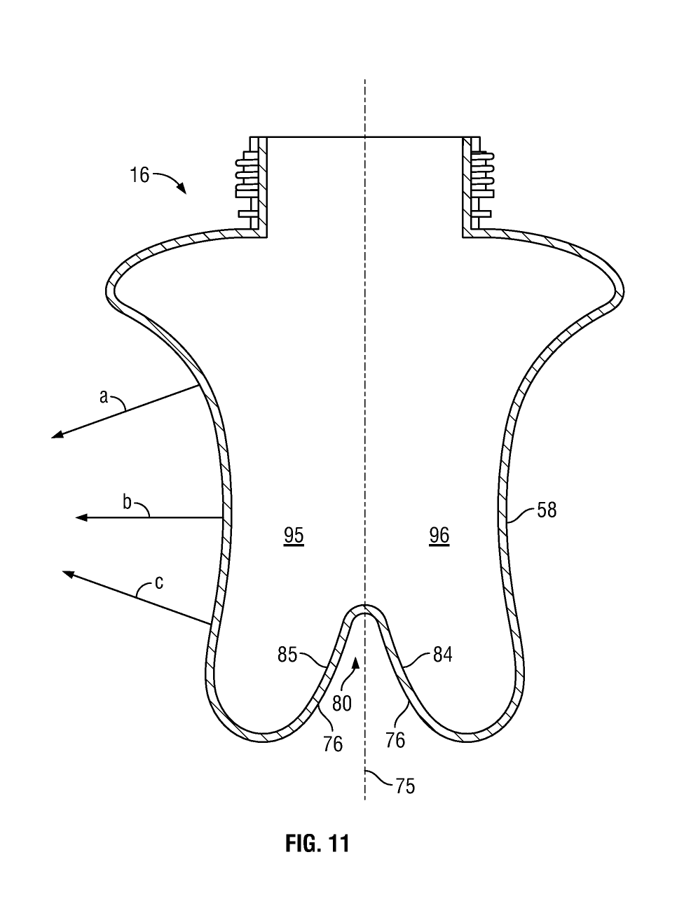

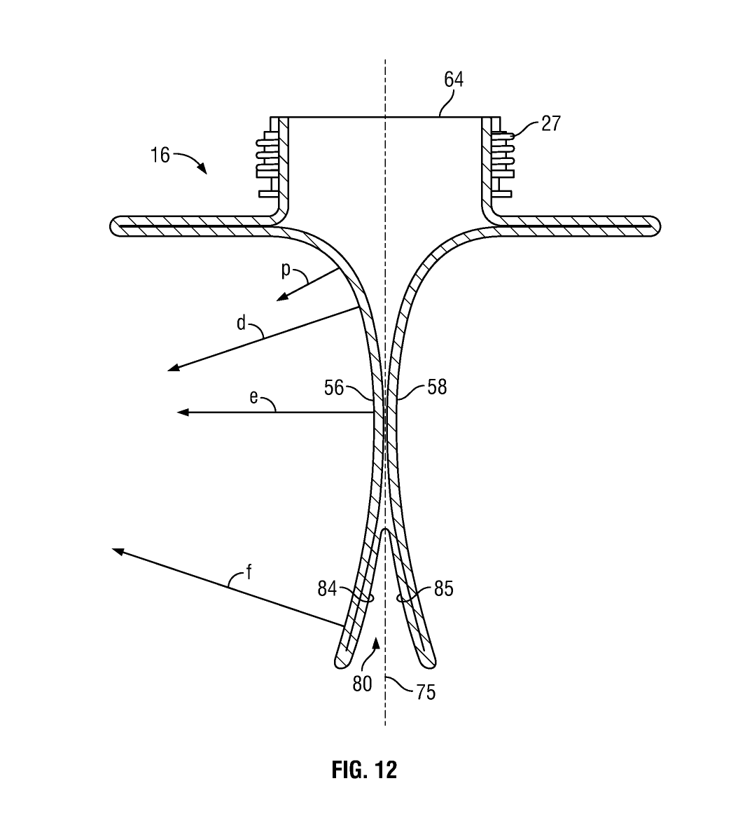

As best seen in the cross-sectional views of FIGS. 7 and 10, a front compartment 196 is formed within the bottle 16 forwardly of the central plane 75 and notably defined between the side walls 60 and 62 and between the front valley walls 84 of the groove 80 in each side wall and the front wall 56. Similarly, a rear compartment 197 is formed within the bottle 16 rearwardly of the central plane 75 and notably defined between the walls 60 and 62 and between the rear valley walls 85 of the groove 80 in each side wall and the rear wall 58. The front compartment 196 is bounded in part forward of the groove 80 by the top wall 66, right side wall 60, left side wall 62 and the front wall 56. The rear compartment 197 is bounded in part rearward of the groove 80 by the bottom wall 76, right side wall 60, left side wall 62 and the rear wall 58. With withdrawal of fluid from the bottle 16, the bottle with tend to collapse about each of the front compartment 196 and rear compartment 197. In collapse about the front compartment 196, the front wall 56 is drawn towards the front valley walls 84 towards adopting an intermediate configuration as seen, for example, in cross-sectional views in FIGS. 8 and 11. With further withdrawal of fluid, the container 16 further collapses towards adopting a fully collapsed configuration as indicated in FIGS. 9 and 12.

The three-dimensional shape of the groove 80 as it extends within and across the bottom wall 76 and within and along each of the side walls 60 and 62, provides a stabilizing structure towards which the front wall 56 and rear wall 58 are drawn in collapse of the bottle, with this stabilizing three-dimensional structure tending to lessen the extent to which the front wall 56 or rear wall 58 may be relatively twisted notably about the longitudinal 74.

In accordance with the preferred embodiment of FIG. 2, the bottle 16 has been shown as symmetrical about both the central plane 75 and the transverse plane 77. This is not necessary. The preferred embodiment of FIG. 2 shows the bottle 16 as having a generally rectangular shape as seen, for example, in bottom view of FIG. 5, This is not necessary and bottles which have shapes other than rectangular such as including a generally cylindrical shape, shapes in which one of the front or rear face may be curved or arcuate or multifaceted as seen in end view, and shapes in which the bottle may have a varying cross-sectional shape from the outlet end to the base end as, for example, to reduce in cross-sectional area from the outlet end of the base end. Such various shapes and configurations may be provided so as, for example, to maximize the interior volume for the bottle to hold fluid within, for example, an interior cavity between a housing 12 and a cover 14 having regard tier the need for various other components of the dispenser to also be housed within the housing.

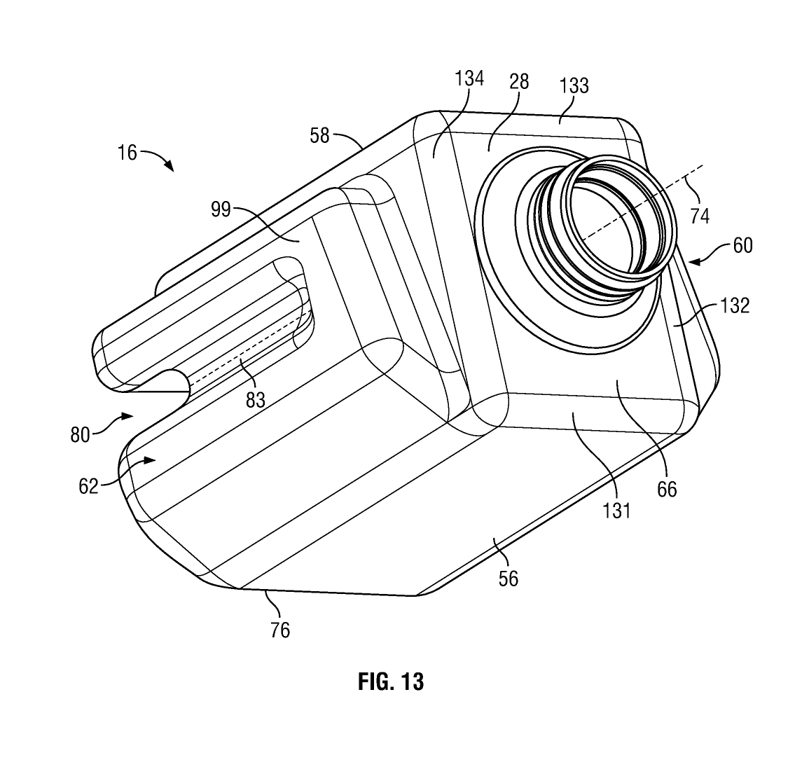

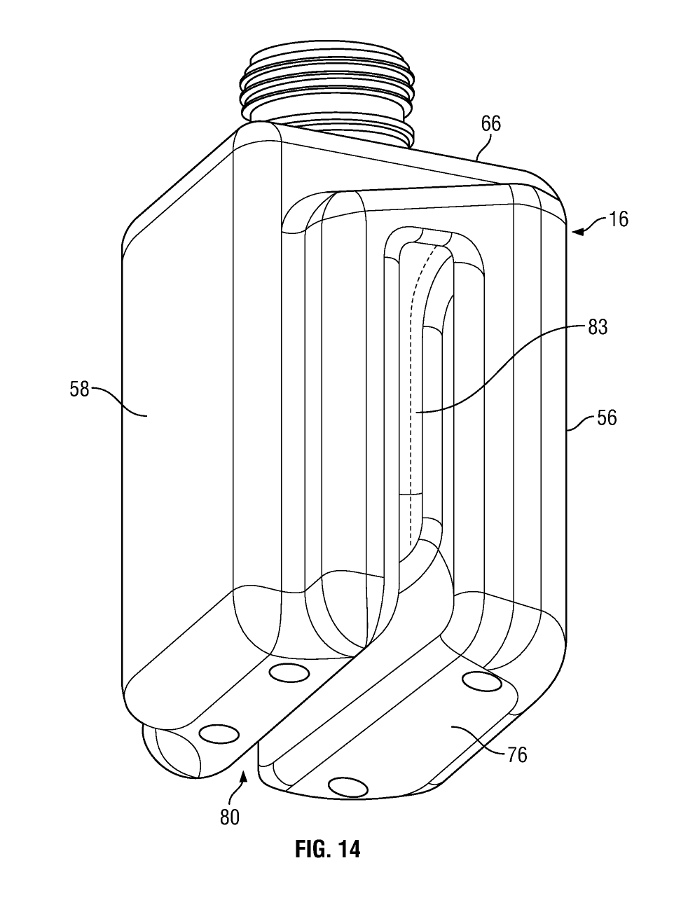

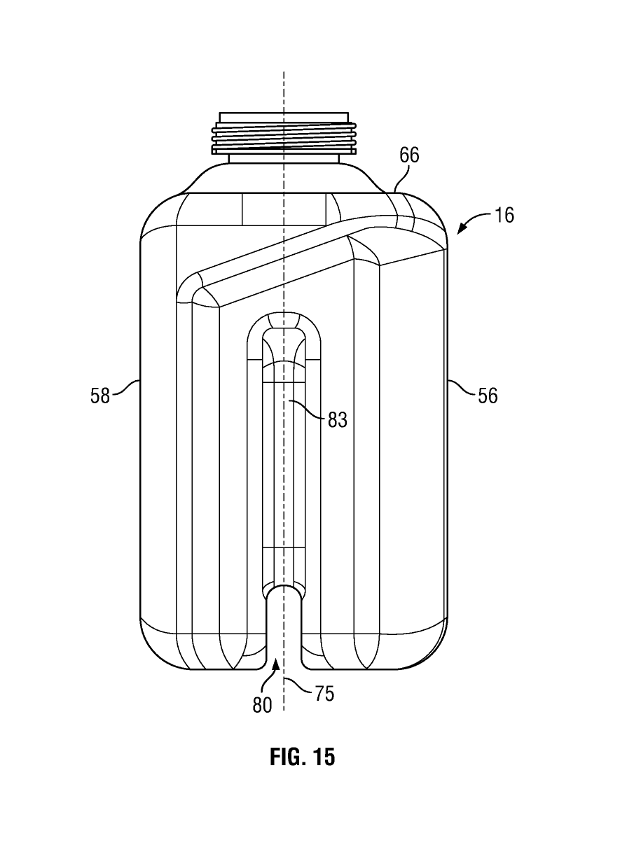

Reference is made to FIGS. 13 to 16 which illustrate another bottle 16 in accordance with a second embodiment of the present invention. In FIGS. 13 to 16, similar reference numerals are used to indicate similar elements to those in FIGS. 1 to 12. The bottle 16 of FIG. 13 is roughly shown in the sketches and is provided to be symmetrical about a transverse plane 77, however, not symmetrical about a central plane 75. However, the medial groove 80 is symmetrical about the central plane 75 which is spaced inwardly from the front wall 56 a greater extent than the central plane 75 is spaced inwardly from the rear wall 58. In this embodiment of FIG. 13, the side walls 60 and 62 are not flat or planar but rather have sideways protrusions 99 which increase the bottle's volume. FIGS. 13 to 16 show lines as indicating either the outline of the bottle 16 or locations of a change of the nature of the planes defining the surfaces of the bottle as is common with computer drawings and are provided to assist a person visualizing the bottle. These planes include planar, curved planes and conical planes.

In the embodiment of FIGS. 13 to 16, the valley apex is shown as a dashed line in the middle of a central apex surface 100 at each of the first groove end 81 and the second groove end 82, the groove 80 ends as a relatively flat surface 102.

In the bottle 16 of FIGS. 13 to 16, the top wall 66 has a rectangular central portion 28 which, at its outer periphery, merges with the front wall 56, rear wall 58, right side wall 60 and left side wall 62 via smoothly curved shoulder portions 131, 132, 133 and 134.

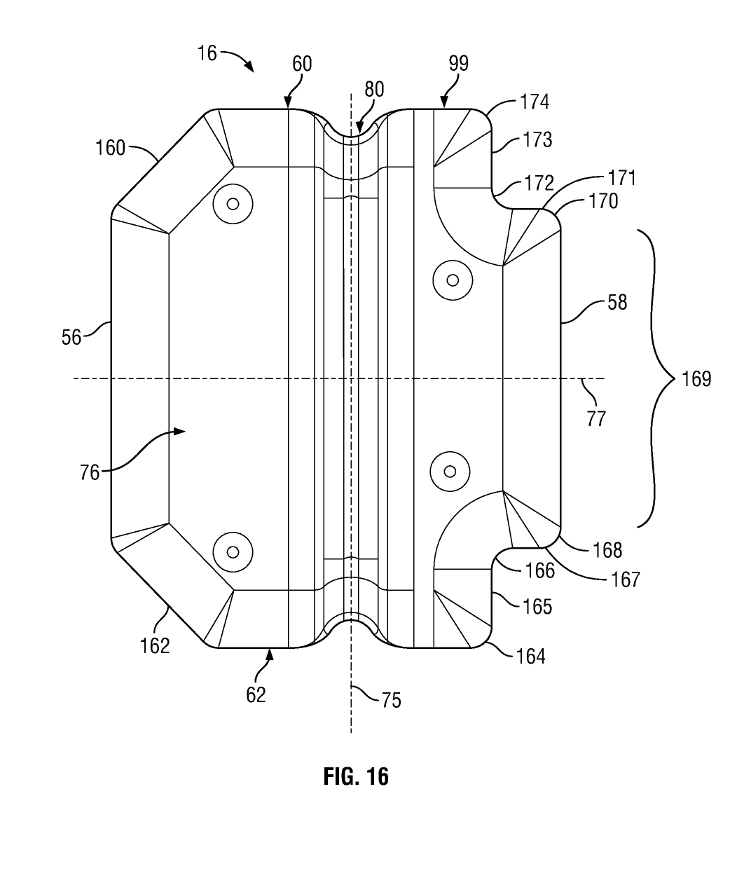

As seen in bottom view in FIG. 16, the bottle 16 has a bottom wall 76 bifulcated by the groove 80 with the groove 80 closer to the rear wall 58 than the front wall 56. While in bottom view of FIG. 16, the bottle 16 has a roughly rectangular shape, the front wall 56 merges into the right side wall 60 via a bevelled corner wall section 160 of the right side wall 60 disposed in a plane parallel the longitudinal 74 and approximately 45′ to each the front wall 56 and the right side wall 60. The front wall 56 merges into the left side wall 62 via a bevelled corner wall section 162 of the left side wall 62 disposed parallel the longitudinal 74 and in a plane approximately 45′ to each of the front wall 56 and the left side wall 62.

Proximate the right side wall 60, the rear wall 58 extends forwardly then sidewardly forming an inside corner between a rear wall right side face and a rear wall.

The rear wall 58 is symmetrical about the central plane 75 and includes a central section 169, a right side section 171, a right rear section 173, aloft side section 167 and a left rear section 165.

The right side section 171 is directed towards the right side and the right rear section 173 is directed towards the rear, The central section merges into the right rear section 171 as a curved outer corner 170. The right side section 171 merges into the right rear section 173 as a curved inside corner 172. The right rear section 173 merges into the right side wall 60 as a curved outside corner 174. Similarly, on the left side outer corner 168, a curved inside corner 166 and a curved outer corner 164 are provided.

The particular cross-sectional profile of the groove 80 is not limited. At each groove end 81 and 82, the groove 80 may preferably end as a first valley end wall and a second valley end wall, respectively, with a surface which extends 180 degrees between the front valley wall 84 and rear valley wall 85. Preferably at each groove end 81 and 82, the surface may curve and, for example, preferably comprise a frusto-conical surface curving 180 degrees between the front valley wall and the rear valley wall.

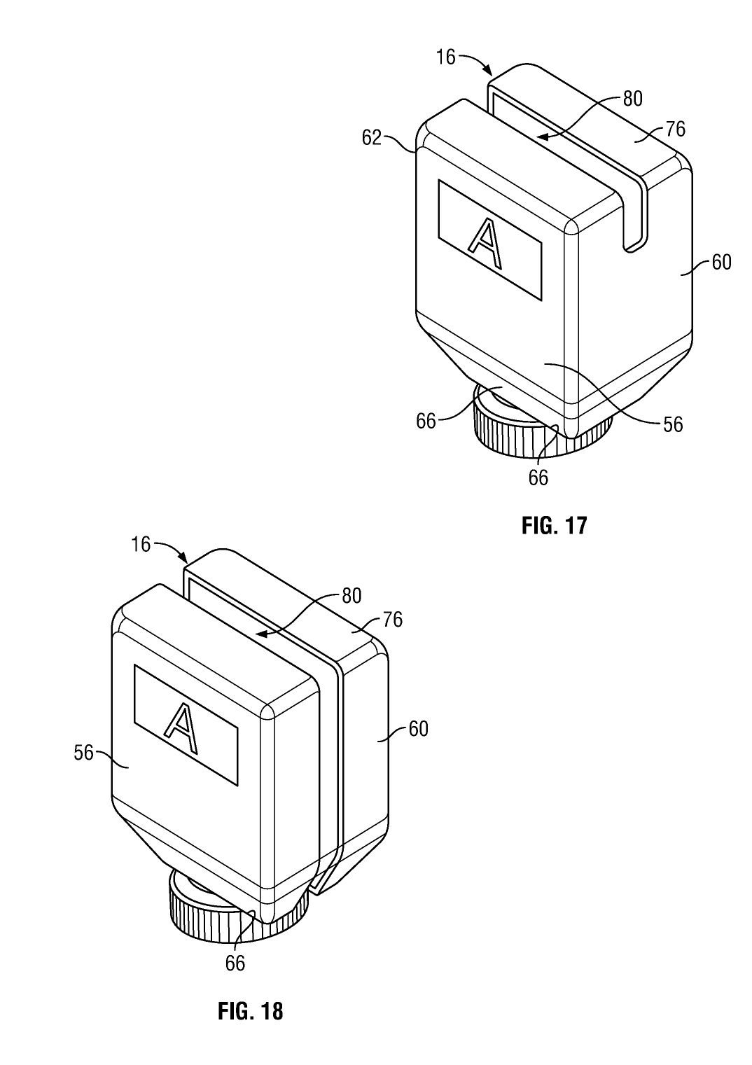

Reference is made to FIG. 17 which shows a third embodiment of a bottle 16 the same as in FIGS. 1 to 11 with the exception that the groove 80 extends from the bottom wall 76 along the side walls 60 and 62 a lesser distance shown as about 25% at a height between the top wall 66 and the bottom wall 76.

Reference is made to FIG. 18 which shows a fourth embodiment of a bottle 16 the same as in FIGS. 1 to 11 with the exception that the groove 80 extends from the bottom wall 76 along the side walls 60 and 62 a greater distance shown entirely between the top wall 66 and the bottom wall 76, and through the top wall 66.

The bottle 16 is indicated on FIGS. 3, 4 and 5 as having a height H between the top wall 66 and the bottom wall 76, a width W between the right side wall 60 and the left side wall 62, a depth D between the front wall 56 and the rear wall 58.

The first groove end 81 and second groove end 82 are located the distance from the bottom wall 76 indicated on FIG. 3 as GSL representing the groove side length.

The bottle 16 of FIG. 2 is rectangular in cross-section normal the longitudinal 74 with a ratio of D to W of about 3:4 representing a ratio of depth to width of 75%. The bottle 16 of FIG. 2 has a height marginally less than its width, that is, with the ratio W:H of about 1:1. The bottle 16 of FIG. 2 has a ratio of D:W of about 5:6 or 83%.

The bottle 16 of FIG. 13 has a ratio of D:W of about 4:5 or 80% and a ratio of D:H of about 2:3 or 67%.

Preferably, in accordance with the present invention, the bottles may have a ratio of D:W in the range of 1:1 to 1:3 or 100% to 33%, more preferably, 4:5 to 3:5 or 80% to 60%; or 4:5 to 3:4 or 80%.

The bottle 16 of FIG. 2 has the groove 80 extend along each side wall to the respective groove end about 75% of the height H, that is, with the ratio of GSL:H being about 3:4. In the bottle 16 of FIG. 13, the ratio GSL:H is about 4:5 or 80%. In the bottle 16 of FIG. 17, the ratio GSL:H is 1:4 or 25%. In the bottle 16 of FIG. 18, the ratio GSL:H is 1:1. Preferably, the groove 80 extends along each side wall at least 25% and, more preferably, at least 50% of the height of the bottle along the length of each side wall, more preferably, at least 75% or 80%.

The bottle 16 of FIG. 2 has the groove 80 with a depth from the bottom wall 76 DB of about 25% of the length L, that is, with a ratio of DB:L of about 1:4. The bottle 16 of FIG. 13 has a ratio of DB:L of about 1:6 or about 17%. Preferably, the depth DB of the groove 80 from the bottom wall 76 is in the range of about 15% to 33% of the length L, more preferably, 15% to 25%, or 20% to 25% of the length L. The depth DB of the groove 80 from the bottom wall 76 is considered to be as important a dimensional characteristic as other dimensional characteristics.

The bottle 16 of FIG. 2 has the groove 80 with a depth from each side wall of DLS and DRS equal with the ratio of the depth of the groove in each side wall to the depth of the groove in the bottom wall with DLS:DB being 2:3. In the bottle 16 of FIG. 13, the ratio DLS: DB is about 2:5. Preferably, the ratio of DLS:DB is in the range of 1:1 to 1:5, more preferably, 4:5 to 2:5 or 2:3 to 2:5.

FIG. 10 shows the width WG of the groove 80 between the front valley wall 84 and the rear valley wall 85. in the bottle 16 of FIG. 2, a ratio of groove width WG to bottle depth D is about 1:9. In the bottle 16 of FIG. 13, WG:D is about 1:7, in accordance with the invention, WG:D may preferably be in the range of 1:6 to 1:12, however, the dimension WG may very considerably.

An advantage of the present application is that by reason of the groove 80, the bottle collapses in a controlled manner so as to present substantial portions of the front wall 56 to continue to be directed sufficiently forwardly that a person viewing the front wall 56 forwardly of the bottle 16 may be able to read the visual indicia 96 provided on the forward wall 56 as on the label 95. It is to be appreciated, however, that the front wall 56 need not be disposed parallel to the center plane 75 in order that visual indicia 96 may be read by a user. For example, visual indicia 96 disposed in a plane at an angle to the central plane 75 may nevertheless be read provided the visual indicia is not in a plane at too great an angle to the central plane. On FIGS. 7 to 12, various arrows a to p are shown with each arrow extending as a straight line perpendicular to a tangent of the surface of the front wall 56 of the bottle at a point where the arrow intersects the surface of the front wall of the bottle 56 in the respective cross-section shown. Referring to FIG. 12, arrow e is perpendicular to the central plane 75. Arrow d and arrow f are each disposed at an angle which is 70° to the central plane 75. In FIG. 12, the section of the front wall 56 which is between the arrows d and f is disposed at angles between 90° and 70° to the central plane 75. Reference is made to FIG. 11 which similarly shows an arrow b which is normal to the central plane 75 and two arrows a and c, each of which is disposed at 70° to the central plane 75 such that the section of the front wall 56 between the arrows a and c in the partially collapsed condition of FIG. 11 is disposed at angles of between 90° and 70° to the flat central plane 75.

The relative points along the front wall 56 at which each of the arrows a to f intersect with the front wall 56 in FIGS. 11 and 12 have been superimposed on FIG. 10 identifying the relative location of each of these arrows in the uncollapsed bottle of FIG. 10. In FIG. 10, each of the arrows a to f extends perpendicular to the central plane 75 as would be the case in the uncoilapsed bottle. Thus, in FIG. 10, the label 95 disposed. between arrow c and arrow d would be maintained within a range of 90° to 70° of the flat central plane 75 in the collapse of the bottle from the uncollapsed position of FIG. 10 through the intermediate collapsed position of FIG. 11 to the fully collapsed position of FIG. 12.

Reference is made to FIG. 7 which shows arrows n and o as being directed from the front wall 56 perpendicular to the central plane 75 as seen in top view. FIGS. 9 and 10 show the relative locations of the arrows n and o on the partially and fully collapsed bottle 16. In FIG. 8, arrows indicated h and j identify arrows disposed at 70° to the center plane 75 and arrow i, a centrally located arrow perpendicular to the center plane 75, thus, the surface of the front wall 56 is disposed at angles of between 90° and 70° to the center plane 75 between the arrows h and j. In FIG. 9, arrows k and m are disposed at 70° to the central plane 75. Center arrow I is disposed 90° to the central plane 75. In FIG. 9, the front wall 56 between the arrows k and m are disposed between 90° and 70° to the central plane 75. As can be seen in each of FIGS. 8 and 9, the front wall 56 between the arrows n and o is, at all times, disposed between 90° and 70° to the central plane.

Reference is made to FIG. 3 on which there is marked by cross-hatching the label 95 which is bounded at its bottom by a line 190, at its top by a line 191, at its right side by a line 192 and its left side 193. The bottom line 190 represents the location of line c on the front wall 56 on FIG. 10 and the top line 191 represents the location of line d on the front wall 56 in FIG. 10. The right side line 192 represents the location of the arrow o and the left line 192 represents the location of the arrow o. The left side line 193 represents the location of the arrow n. Thus, the rectangular label 195 represents an area on the front wall 75 which will have its surface directed forwardly at angles between 90° and 70° to the central plane 75 during all conditions of the bottle between the full on collapsed position of FIGS. 7 and 10 and the fully collapsed position of FIGS. 9 and 12. Thus, the rectangular area of the label 95 comprises a preferred area within which visual indicia 96 may be provided to be readable by a person viewing the bottle 16 from the front indicia which is to be preferred to be read during all collapsed and uncollapsed conditions of the bottle may preferably be provided within this rectangular area of the label 95 on the front wall 56. Different criteria for the acceptable relative angle of the surface of the front wall 56 may be selected as appropriate for viewing forwardly. For example, FIG. 12 illustrates as arrow p in an arrow disposed at 60° to the central plane 75. An angle of 60° as well as other angles such as any angle between 45° and 90% may preferably be selected as acceptable for viewing. The area of a label to accommodate, for example, such 60° to 90° viewing would be appreciated to be larger than the area of the label 95.

In accordance with the present invention, the bottle 16 when collapsed provides a useful portion of its front wall 56 as disposed at angles relative to the central plane 75 as to be useful for viewing visual indicia 96 provided thereon. For example, the preferred area of the label 95 in FIG. 3 comprises approximately 30% of the area of the front wall 56. Preferably, the bottle 16 when collapsed will provide a preferred labelling area disposed at a preferred angle to the central plane over an area of at least 10%, more preferably, at least 20%, more preferably, at least 30% of the surface area of the front wall.

In accordance with the present invention, where the bottle 16 is to be secured within a housing 10 with a window such as the window opening 13 is provided through which the bottle 16 is capable of being viewed by a user, then the window opening 13 is preferably located relative to the fixed outlet end for the bottle, that during collapse of the bottle 16, the preferred labelling area of the label 95 will continue to be visible through the window opening 13 when the bottle is uncollapsed and when the bottle is fully collapsed and all conditions in between. For example, as seen in FIG. 1, in the assembled dispenser when the bottle 16 is uncollapsed and full of fluid, if viewed horizontally from the front, the label 95 would be visible in the upper portion of the window opening 13, however, when the bottle is fully collapsed, the label 95 would be visible in the lower portion of the window opening 13. The window opening 13 is provided with a vertical extent which would accommodate the relative vertical movement of the label 95 relative the outlet opening 64 from the position in FIG. 10 to the position in FIG. 12 in which the label is moved closer to the outlet 64 with collapse of the bottle.

While the invention has been described with reference to preferred embodiments, many modifications and variations will now occur to persons skilled in the art. For a definition of the invention, reference is made to the following claims.

We claim:

1. A thin walled collapsible container,
the container comprising an outlet end, a closed base end, a front wall, a rear wall and two side walls, namely a first side wall and second side wall,
the container closed but for an opening from the outlet end,
the outlet end having a top wall, the top wall including a central portion about a neck open to the opening, the top wall merging with the front, rear and two side walls,
the front, rear and two side walls extending longitudinally of the container from the outlet end to the base end,
the base end having a bottom wall merging into the front, rear and two side walls,
an inwardly extending medial groove between the front wall and the rear wall within each of the first side wall, the bottom wall and the second side wall extending continuously from within the first side wall, downwardly within the first side wall across the bottom wall within the bottom wall and upwardly within the second side wall within the second end wall.

2. A collapsible container as claimed in claim I wherein:
the groove extends from a first groove end within the first side wall downwardly within the first side wall across the bottom wall within the bottom wall and upwardly within the second side wall to a second groove end within the second end wall.

3. A collapsible container as claimed in claim 2 wherein:
the first groove end within the first side wall is spaced downwardly from the top wall,
the second groove end within the second end wall is spaced downwardly from the top wall,

4. A collapsible container as claimed in claim 3 wherein:
the first groove end is closer to the top wall than the bottom wall,
the second groove end is closer to the top wall than the bottom wall.

5. A collapsible container as claimed in claim 4 wherein:
the first groove end is proximate the top wall, and
the second groove end is proximate the top wall,

6. A collapsible container as claimed in claim 1 wherein:
the groove extends in the first side wall towards the outlet end through the top wall presenting a first groove end open outwardly through the top wall, and
the groove extends in the second side wall towards the outlet end through the top wall presenting a second groove end open outwardly through the top wall.

7. A collapsible container as claimed in claim wherein on collapsing of the container under a vacuum applied to withdraw fluid from the outlet end, each of the front wall and the rear wall is drawn towards each other with each of the first side wall, the second side wall and the bottom wall folding about the groove.

8. A collapsible container as claimed in claim l wherein the front, rear and two side walls extending longitudinally of the container from the outlet end to the base end about a longitudinal of the container parallel an axis coaxially through the neck.

9. A collapsible container as claimed in claim 8 including a flat central plane including the longitudinal intermediate the first side wall and the second side wall,
wherein the container is symmetrical about the central plane.

10. A collapsible container as claimed in claim 9 including a flat transverse plane including the longitudinal intermediate the front wall and the rear side wall, the container symmetrical about the transverse plane.

11. A collapsible container as claimed in claim 9 herein on collapsing of the container under a vacuum applied to withdraw fluid from the outlet end each of the front wall and the rear wall are drawn towards each other with each of the first side wall, the second side wall and the bottom wall folding about the groove and maintaining portions of the front wall and rear wall disposed parallel the central plane.

12. A collapsible container as claimed in claim 1 wherein the groove is formed by a front valley wall and a rear valley wall extending inwardly to a valley apex.

13. A collapsible container as claimed in claim 19 wherein each of the first valley end wall and the second valley end wall is symmetrical relative to each other.

14. A collapsible container as claimed in claim 12 wherein at the first groove end of the groove a first valley end wall bridges between the front valley wall and the rear valley, and
at the second groove end of the groove a second valley end wall bridges between the front valley wall and the rear valley.

15. A collapsible container as claimed in claim 14 wherein the front, rear and two side walls extending longitudinally of the container from the outlet end to the base end about a longitudinal of the container parallel an axis coaxially through the neck,
a flat central plane including the longitudinal intermediate right side wall and the left side wall,
each of the first valley end wall and the second valley end wall presents a surface symmetrical about the central plane, and
each of the first valley end wall and the second valley end wall presents a surface symmetrical about the central plane.

16. A collapsible container as claimed in claim 1 wherein the groove including:
a. a bottom groove portion in the bottom wall extending inwardly towards the outlet end between the front wall and the rear wall,
b. a first side groove portion extending inwardly within e first side wall towards the second side wall between the front wall and the rear wall, and
c. a second side groove portion extending inwardly within the second side wall towards the first side wall between the front wall and the rear wall.

17. A collapsible container as claimed in claim 16 wherein the bottom groove portion at a first end merges smoothly into the first side groove portion, and
the bottom groove portion at a second end merges smoothly into the second side groove portion

18. A collapsible container as claimed in claim 17 wherein the groove has a constant cross-sectional profile along its length.

19. A collapsible container as claimed in claim 11 wherein the top wall has a generally rectangular perimeter as seen in end view,
the bottom wall has a generally rectangular perimeter as seen in end view,
the annular central portion being annular about the neck,
the top wall including peripheral edge portions about the central portion merging with the front, rear and two side walls; and
the bottom wall having support portions disposed in a flat plane normal to the longitudinal of the container and serving to support the container on a horizontal support. surface with the longitudinal of the container to extend vertically upwardly.

20. A collapsible container as claimed in claim 11 in combination with a dispenser to dispense fluid from the container to create a vacuum within the container which collapses the container as fluid is dispensed,
the dispenser engaging the outlet end of the container with the front wall directed in a first direction when the container is full of fluid,
the front wall carrying visual indicia perceptive from the direction in which the front wall is directed.
